(19) United States
(12) Patent Application Publication
(10) Pub. No.: US 2014/0095615 A1
(43) Pub. Date: Apr. 3, 2014

(54) Communication Terminal, Remote Conference System and Control Program for Communication Terminal

(71) Applicant: Katsuaki Ito, Nagoya-shi (JP)

(72) Inventor: Katsuaki Ito, Nagoya-shi (JP)

(73) Assignee: BROTHER KOGYO KABUSHIKI KAISHA, Nagoya-shi (JP)

(21) Appl. No.: 14/034,679

(22) Filed: Sep. 24, 2013

(30) Foreign Application Priority Data
Sep. 28, 2012 (JP) 2012-216208

(51) Int. Cl. H04L 29/06

(52) U.S. Cl. CPC H04L 65/403
USPC 709/204

(57) ABSTRACT

A communication terminal is configured to execute detecting a first quality value indicating a quality of connection with a first conference server which communicates media data relating to a remote conference with the communication terminal, determining whether the quality of connection is lower than a predetermined quality based on the first quality value, when it is determined that the quality of connection is lower than the predetermined quality, outputting a conference state storing instruction to store a state of an ongoing remote conference, disconnecting a network connection with the first conference server after conference state information indicating the state of the ongoing remote conference is stored, reconnecting the network connection with the first conference server after the network connection is disconnected, and when the network connection is reconnected with the first conference server, resuming the ongoing remote conference based on the stored conference state information.

### CROSS-REFERENCE TO RELATED APPLICATION

This application claims priority to Japanese Patent Application No. 2012-216208 filed on Sep. 28, 2012, the content of which is hereby incorporated herein by reference.

### TECHNICAL FIELD

The disclosure relates to a communication terminal which executes a remote conference by transmitting and receiving media data to and from another communication terminal connected to a conference control unit via a network.

### BACKGROUND

There has been known a remote conference system which executes a remote conference by installing a communication terminal capable of inputting/outputting image or sound of users in each location and transmitting and receiving image and/or sound acquired by each communication terminal to and from the other communication terminals installed in the other locations via a network and conference server.

For example, a video conference system is configured such that when a network connection between a plurality of terminals and a conference server is disconnected during a video conference, a network for a disconnected communication terminal is automatically reconnected as necessary.

### SUMMARY

A remote conference by the above-described remote conference system is executed by transmitting and receiving image and/or sound acquired by each communication terminal to and from the other communication terminals installed in the other locations via a network and a conference server. When a connection quality of each network is in a low state, there is caused missing or deterioration of the image or sound. The low state of the connection quality may include a state where a communication speed (i.e., transfer rate) is low, a delay time is long or a packet loss ratio is large with respect to predetermined thresholds, respectively. The missing or deterioration of the image or sound would cause decrease in the amount of information transmitted to conference participants using each communication terminal. Therefore, the connection quality is important.

As a method for improving the connection quality in the network connection, there is a method in which conference participants at the communication terminal perform an operation to manually disconnect and reconnect the network. However, when such an operation is required to improve the connection quality, a complicated impression is given to the conference participants. Further, when the reconnection of the network is requested at the same time from a plurality of communication terminals, the network becomes busy, so that it takes time to reconnect the network.

When the network connection is disconnected during the remote conference in order to improve the connection quality in the network connection, a conference state before disconnection is not maintained. The conference state refers to information indicating various states relating to a remote conference. The information may include data indicating material shared in the remote conference, authority information which is assigned to each user ID and indicates an execution authorization (chairman, presenter, participants and the like) for functions of a remote conference application, a mute setting of each user ID, layout information indicating a screen display position on a communication terminal of each user ID. In order to smoothly resume the remote conference interrupted by the disconnection, it is necessary to perform a resume process according to the conference state, for example, re-share the material data in the remote conference.

In this regard, the related-art video conference system is configured to automatically reconnect the network for the disconnected communication terminal as necessary when the network connection is disconnected during a remote conference. Therefore, the connection is maintained, for example, even in a state where the connection quality is low, until the network connection is actually disconnected. Accordingly, in the related-art video conference system, there is a case in which the remote conference continues in a state where missing or deterioration of the image or sound is caused. Further, in the related-art video conference system, since the condition of the material or the progress of the remote conference is not maintained before disconnecting the network connection, it is difficult to smoothly resume the remote conference even when the reconnection is automatically performed.

The disclosure relates to a communication terminal which executes a remote conference by transmitting and receiving media data to and from another communication terminal connected to a conference control unit via a network, and provides a communication terminal which enables the remote conference via high-quality network connection and can smoothly resume the remote conference after when reconnecting to the network.

According to an aspect of the disclosure, there is provided a non-transitory computer-readable medium storing computer-readable instructions that, when executed by a processor of a communication terminal, instruct the processor to perform processes including: detecting a first quality value indicating a quality of connection with a first conference server based on a packet transmitted to the first conference server and a packet received from the first conference server, wherein the first conference server is configured to communicate media data relating to a remote conference with the communication terminal; determining whether the quality of connection with the first conference server is lower than a predetermined quality based on the first quality value; when it is determined that the quality of connection with the first conference server is lower than the predetermined quality, outputting a conference state storing instruction to store a state of an ongoing remote conference; disconnecting a network connection with the first conference server after conference state information indicating the state of the ongoing remote conference is stored in response to the conference state storing instruction; reconnecting the network connection with the first conference server after the network connection is disconnected; and when the network connection is reconnected with the first conference server, resuming the ongoing remote conference based on the stored conference state information.

According to another aspect of the disclosure, there is provided a communication terminal including: a processor; and memory storing computer-readable instructions that, when executed by a processor, instruct the processor to perform processes. The processes include: detecting a first quality value indicating a quality of connection with a first conference server based on a packet transmitted to the first conference server and a packet received from the first conference server, wherein the first conference server is configured to communicate media data relating to a remote conference with the communication terminal; determining whether the quality of connection with the first conference server is lower than a predetermined quality based on the first quality value; when it is determined that the quality of connection with the first conference server is lower than the predetermined quality, outputting a conference state storing instruction to store a state of an ongoing remote conference; disconnecting a network connection with the first conference server after conference state information indicating the state of the ongoing remote conference is stored in response to the conference state storing instruction; reconnecting the network connection with the first conference server after the network connection is disconnected; and when the network connection is reconnected with the first conference server, resuming the ongoing remote conference based on the stored conference state information.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is an explanatory view showing an example of a configuration of a remote conference system according to an illustrative embodiment;

FIG. 2 is a block diagram showing a control system of a conference terminal according to the illustrative embodiment;

FIG. 3 is a block diagram showing a control system of a conference server according to the illustrative embodiment;

FIG. 4 is an explanatory view showing an example of conference information;

FIG. 5 is a sequence diagram in a connection quality monitoring process;

FIG. 6 is an explanatory view showing an example of contents of connection quality information in the conference terminal;

FIG. 7 is a flowchart in a conference state maintaining process;

FIG. 8 is an explanatory view showing an example of image quality information;

FIG. 9 is an explanatory view showing an example of connecting server information;

FIG. 10 is a sequence diagram in a disconnection process;

FIG. 11 is an explanatory view showing an example of connection quality information acquired from the conference server; and

FIG. 12 is a sequence diagram in a reconnection process.

### DETAILED DESCRIPTION

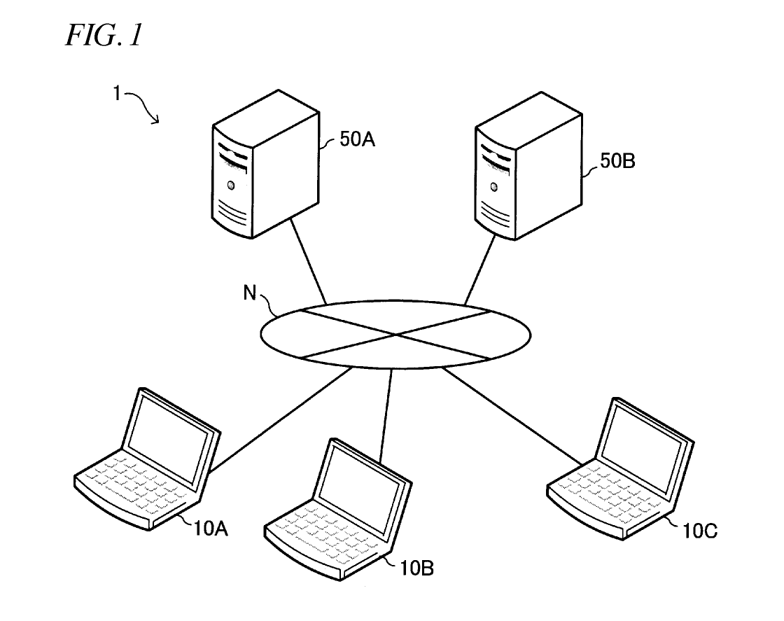

First, a configuration of a remote conference system 1 according to the present illustrative embodiment will be described in detail with reference to FIG. 1. As shown in FIG. 1, the remote conference system 1 is configured to execute a remote conference (video conference) using images and sounds. For example, in the remote conference system 1, a plurality of conference terminal 10A, 10B, 10C, each corresponding to a communication terminal and a plurality of conference server 50A, 50B are respectively connected to each other via a network N. Incidentally, in the illustrative embodiment, the conference terminals 10A, 10B, 10C are referred to as “conference terminal 10” when these conference terminals are not distinguished or these conference terminals are collectively referred. In addition, the conference servers 50A, 50B are referred to as “conference server 50” when these conference servers are not distinguished or these conference servers are collectively referred.

In the remote conference system 1, each conference terminal 10 is connected to any one of the plurality of conference servers 50 via a network N and used by a user participating in a remote conference. Each conference terminal 10 corresponds to the communication terminal and can be configured by connecting a camera 33, a microphone 34 or the like, which will be described later, to a general-purpose personal computer, for example. During the remote conference, each conference terminal 10 transmits and receives image data acquired by the camera 33, sound data acquired by the microphone 34 and material data such as documents or moving images used in the remote conference to and from the other conference terminal 10 participating in the remote conference via the network N and the conference server 50. In the following description, the data used in the remote conference, including the image data (still image and moving image) and sound data acquired in each conference terminal 10, shared material used in the remote conference, and the like, is referred to as a “media data”.

Each conference server 50 is connected to another conference server 50 via a network N. Each conference server 50 controls a remote conference executed among a plurality of conference terminals 10. Each conference server 50 relays the media data received from each conference terminal 10 via the network N and the other conference server 50, thereby transmitting and receiving the media data to and from the other conference terminal 10 participating in the remote conference. As a result, the media data created in a plurality of conference terminals 10 is shared within the remote conference system 1. In the remote conference system 1, participants can smoothly execute the conference even when all of the conference participants are not in the same place. Furthermore, this remote conference control is same as the related-art control, and therefore, a detailed description thereof is omitted in this illustrative embodiment.

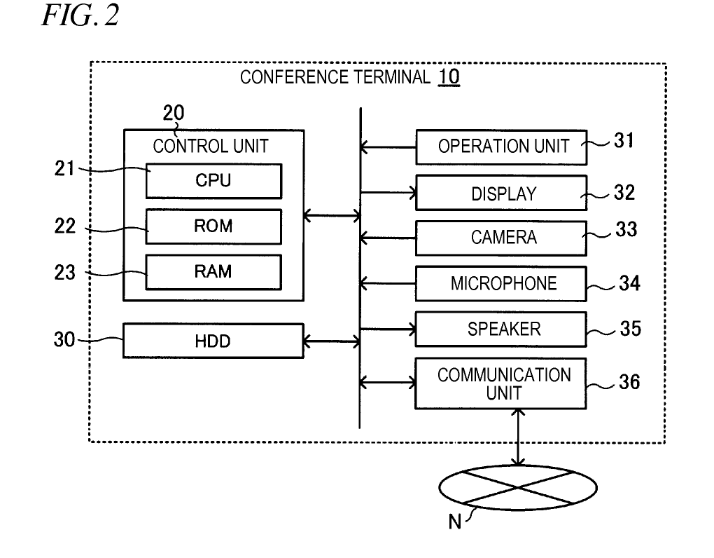

Next, a control system of the conference terminal 10 will be described with reference to FIG. 2. The remote conference system 1 according to the illustrative embodiment includes a plurality of conference terminals 10 (i.e., a conference terminal 10A, a conference terminal 10B and a conference terminal 10C). Each conference terminal 10 has basically the same control system configuration except for different installation locations. Accordingly, in the following description, a control system configuration of one conference terminal 10 is described, and a control system configuration of the other conference terminals 10 is omitted.

As shown in FIG. 2, the conference terminal 10 includes a control unit 20 for controlling the conference terminal 10. The control unit 20 includes a CPU 21, a ROM 22 and a RAM 23. The CPU 21 is a central processing unit to execute various control programs in the conference terminal 10 and the ROM 22 stores booting program, BIOS (Basic Input/Output System) and OS (Operating System). The RAM 23 temporarily stores the results of operations when executing a timer, counter or control program.

The control unit 20 is electrically connected to a HDD 30 (Hard Disk Drive), an operation unit 31, a display 32, the camera 33, the microphone 34, a speaker 35 and a communication unit 36. The HDD 30 stores various control programs to be executed by the CPU 21 or various programs such as application program regarding a remote conference. For example, at set-up of the conference terminal 10, programs stored in CD-ROM or DVD-ROM are read by a media drive (not-shown) and stored in the HDD 30. Incidentally, the conference terminal 10 may receive those programs from one of the conference servers 50 or another server via the network N and stored in the HDD 30. In this case, the programs may be stored in a recording medium such as HDD provided in a server connected via the network N. The HDD 30 stores a data table or the like which is used when executing the remote conference.

The operation unit 31 is a keyboard or a mouse for receiving input from the conference participants. The display 32 is a display device for displaying a desired image and displays image data transmitted as the above-described media data from the other conference terminals 10. The camera 33 acquires image data that is obtained by capturing the image in the locations of the conference terminals 10 when executing the remote conference. The microphone 34 acquires sound data that is obtained by recording the sound in the locations on the conference terminals 10 when executing the remote conference. The speaker 35 reproduces and outputs the sound data transmitted as the above-described media data from the other conference terminals 10. The communication unit 36 executes timing control when communicating with the other conference terminals 10 participating in the remote conference via the network N.

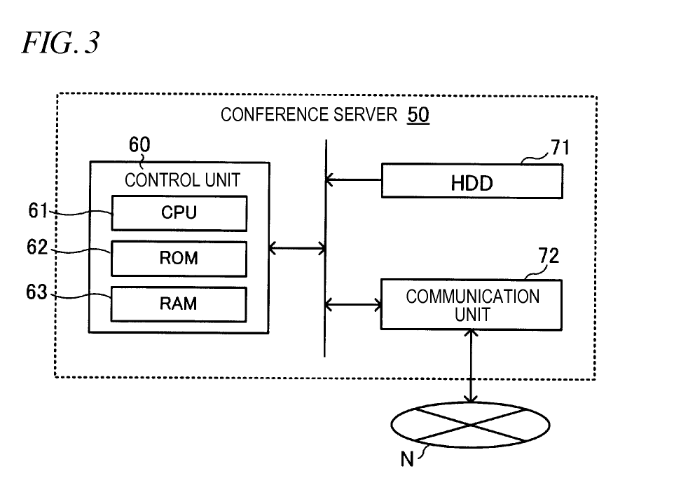

Next, a control system of the conference server 50 will be described with reference to FIG. 3. The remote conference system 1 according to the illustrative embodiment includes a plurality of conference servers 50 (i.e., a conference server 50A and a conference server 50B). Each conference server 50 has basically the same control system configuration except for different installation locations. Accordingly, in the following description, a control system configuration of one conference server 50 is described, and a control system configuration of the other conference server 50 is omitted.

As shown in FIG. 3, the conference server 50 includes a control unit 60 for controlling the conference server 50. The control unit 60 includes a CPU 61, a ROM 62 and a RAM 63. The CPU 61 is a central processing unit to execute various control programs in the conference server 50 and the ROM 62 stores booting program, BIOS (Basic Input/Output System) and OS (Operating System). The RAM 63 temporarily stores the results of operations when executing a timer, counter or control program.

Further, the control unit 60 is electrically connected to the HDD 71 and a communication unit 72. The HDD 71 is a mass storage device capable of storing various data and can record the media data or the like transmitted and received when executing the remote conference. The communication unit 72 controls the data communication when relaying various data transmitted and received from each conference terminal 10 during executing the remote conference.

Next, a basic flow of the remote conference to be executed in the remote conference system 1 shown in FIG. 1 will be described. In the below, a case where a remote conference among the conference terminal 10A, the conference terminal 10B and the conference terminal 10C is executed via the conference server 50 and the conference server 50B has been illustrated. Further, it is assumed that a user of the conference terminal 10A has held a remote conference as an organizer.

Further, in the following description, it is assumed that the conference terminal 10A is a conference terminal (A) used by a user, “Mike”, the conference terminal 10B is a conference terminal (B) used by a user, “Alex” and the conference terminal 10C is a conference terminal (C) used by a user, “John”. In addition, it is assumed that the conference server 50A is a conference server (A) and the conference server 50B is a conference server (B) which is installed in a location different from the conference server 50A.

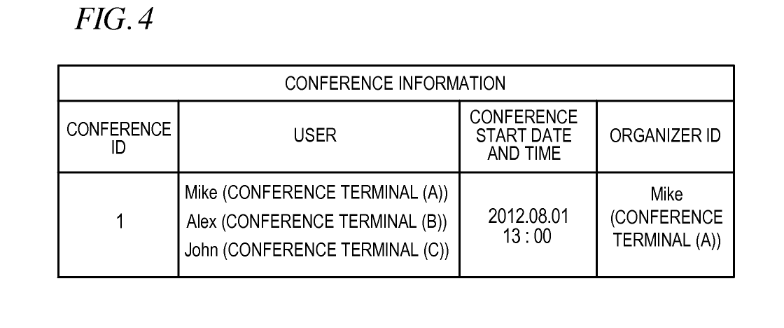

In the remote conference system 1, a user uses the conference terminal 10 to create a conference room on the conference server 50. The conference room is an imaginary space in which the remote conference is executed. In this specific example, as an organizer, a user using the conference terminal 10A creates the conference room on at least one (in this example, the conference server 50A) of the conference server 50A or the conference server 50B. At this time, a user of the conference terminal 10A transmits conference information shown in FIG. 4 to the conference server 50A on which the conference room is created, thereby registering details of the remote conference on the HDD 71 of the conference server 50A.

As shown in FIG. 4, the conference information includes a conference ID, a user indicating a conference participant, a conference start date and time, and an organizer ID. The conference ID is identification information for identifying the conference room created on the conference server 50. The user is information indicating a user participating in the remote conference and, in this specific example, indicates a user of the conference terminal 10A to the conference terminal 10C. In addition, the information indicating the user also includes information for identifying the conference terminal 10 to be used by a user. As an example of the information for identifying the conference terminal 10, IP address is included. The conference start date and time indicates a schedule such as start date and time of the remote conference. The organizer ID is information for identifying a user which is as an organizer of the remote conference and, in this example, the organizer ID is identification information indicating a user of the conference terminal 10A.

When the conference room is created on the conference server 50 in this way, a user set to the conference room participates in a remote conference. Specifically, the conference terminal 10A and the conference terminal 10B are connected to the conference server 50A, and the conference terminal 10C is connected to the conference server 50B, so that the media data can be transmit and received among the conference terminal 10A, the conference terminal 10B and the conference terminal 10C. Further, as an initial setting, it may be determined by the IP address of each conference terminal 10 whether respective conference terminals 10 are connected to either of the conference servers 50, similar to the related-art technique. In addition, each conference terminal 10 stores, in its own RAM 23, the conference ID corresponding to the conference room to be set. For example, when each conference terminal 10 is connected to the conference server 50, the conference ID corresponding to the conference room to be set when each conference terminal 10 is participated is transmitted from the conference server 50 to each conference terminal 10, based on the conference information of the conference server 50. Alternatively, in a mode where each conference terminal 10 is connected to the conference server 50 by specifying the conference ID, the specified conference ID is stored in the RAM 23.

When all users set in the conference information are participated in the remote conference, the remote conference is started. Specifically, the conference terminal 10A and the conference terminal 10B transmit and receive the packets of the media data to and from the other terminals via the conference server 50A and the network N, and the conference terminal 10C transmits and receives the packets of the media data to and from the other terminals via the conference server 50B and the network N. That is, the media data is transmitted and received between the conference terminal 10A and the conference terminal 10B via the conference server 50A. The media data is transmitted and received between the conference terminal 10A and the conference terminal 10C via the conference server 50A, the conference server 50B and the network N. Similarly, the media data is transmitted and received between the conference terminal 10B and the conference terminal 10C via the conference server 50A, the conference server 50B and the network N. Further, the conference server 50 specifies, with reference to the conference information, the conference ID associated with the IP address of the conference terminal 10 to which the media data is transmitted. Then, the media data is transmitted to the other conference terminals 10 participating in the remote conference indicated by the conference ID. Thereby, in the remote conference system 1, the remote conference progresses by frequently transmitting and receiving the media data among the conference terminal 10A to the conference terminal 10C. Meanwhile, the transmission of various instructions other than the media data is similarly executed.

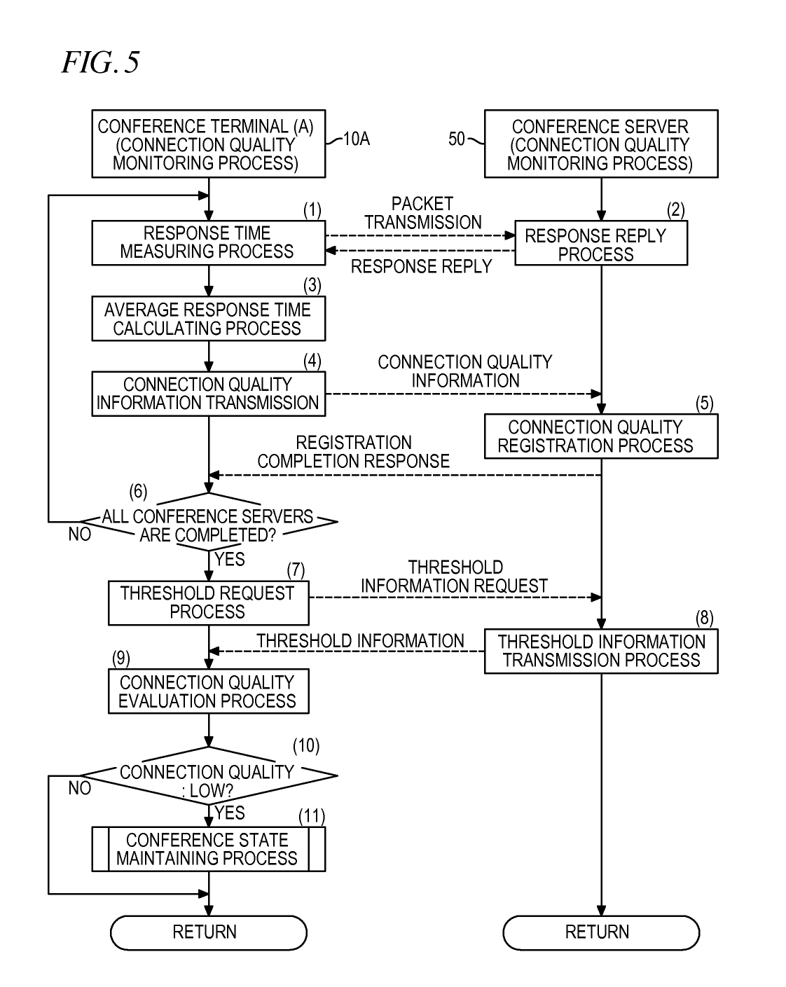

In the remote conference system 1 according to the illustrative embodiment, as the remote conference is started as described above, a connection quality monitoring process is repeatedly executed in each conference terminal 10 participating in the remote conference while the remote conference is executed. Further, although the connection quality monitoring process shown in FIG. 5 illustrates the processing contents to be executed in the conference terminal 10A, the same process is similarly executed in the conference terminal 10B and the conference terminal 10C.

First, the CPU 21 of the conference terminal 10A specifies one (for example, the conference server 50A) of a plurality of conference servers 50 to configure the remote conference system 1 and executes a response time measuring process for the specified conference server 50 (1). Specifically, the CPU 21 transmits a predetermined packet to the specified conference server 50 via the network N. The predetermine packet may be a packet transmitted from the conference terminal 10A to the conference server 50 using a ping command which is available in the OS. Upon receiving the packet, the CPU 61 of the conference server 50 executes a response reply process (2) and transmits a response to the received packet to the conference terminal 10A. That is, in the response time measuring process, the CPU 21 measures a response time (i.e., RTT: Round Trip Time) required to receive a response to the packet from the transmission of the packet, for the conference server 50 to be specified, by multiple times.

When the response time measuring process (1) ends, the CPU 21 of the conference terminal 10A executes an average response time calculating process (3). Specifically, the CPU 21 calculates an average response time that is an average value of the response time between the conference server 50 and the conference terminal using measurement results of multiple times regarding the response time between the certain conference server 50 and the conference terminal, which is measured by the response time measuring process. The average response time is an index indicating the quality of connection with the conference server 50. Here, a packet loss ratio and a communication speed may be measure in addition to or instead of the average response time.

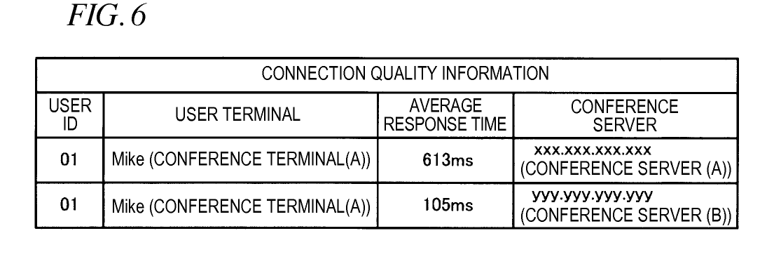

After the average response time calculating process (3), the CPU 21 of the conference terminal 10A transmits the connection quality information to the conference server 50 (4). Here, the connection quality information includes identification information of the conference terminal 10 that is an origin of the packet, identification information of the conference server 50 that is a destination of the packet and the average response time between the conference terminal 10 and the conference server 50, as shown in FIG. 6. The connection quality information may include a packet loss ratio or a communication speed. Upon receiving the connection quality information, the CPU 61 of the conference server 50 registers the received connection quality information in the HDD 71 and transmits a registration completion response indicating the registration completion of the connection quality information to the conference terminal 10 that is a source of the connection quality information (5).

After receiving the registration completion response, the CPU 21 of the conference terminal 10A determines whether or not the registration of the connection quality information is executed for all conference servers 50 that configure the remote conference system 1 (6). The address information of all conference servers 50 configuring the remote conference system 1 is stored in the data table of the HDD 30. When the registration of the connection quality information is executed for all conference servers 50 (in this case, the conference server 50A and the conference server 50B), the CPU 21 of the conference terminal 10A causes the processing to proceed to a threshold request process (7). When there is the conference server 50 for which the registration of the connection quality information is not executed, the processing from the response time measuring process (1) to the connection quality information registration process (6) is executed for the incomplete conference server 50.

In the threshold request process (7), the CPU 21 of the conference terminal 10A requests threshold information stored in the HDD 71 of the conference server 50. The threshold information is a threshold for evaluating the quality of connection with the conference server 50 and indicates a predetermined response time. A predetermined communication speed or a predetermined packet loss ratio may be used as the threshold. Upon receiving the threshold information request, the CPU 61 of the conference server 50 executes a threshold information transmission process (8). Specifically, the CPU 61 reads out the threshold information stored in the HDD 71 and transmits the read-out threshold information to the conference terminal 10 that is a request source of the threshold information.

Upon receiving the threshold information, the CPU 21 of the conference terminal 10A executes a connection quality evaluation process (9). In the connection quality evaluation process, the CPU 21 compares the average response time included in the connection quality information between the currently-connected conference server 50 and the conference terminal with the value (for example, 500 ms) of response time included in the threshold information regarding the conference server 50 and evaluates the quality of connection with the currently-connected conference server 50. Specifically, in a case where the average response time in the connection quality information is larger than the value of response time regarding the threshold information, the CPU 21 evaluates that the quality of connection with the currently-connected conference server 50 is low. On the contrary, in a case where the average response time in the connection quality information is equal to or less than the value of response time regarding the threshold information, the CPU 21 evaluates that the quality of connection with the currently-connected conference server 50 is maintained in a quality above a certain level. Incidentally, in a case where the predetermined communication speed is used as the threshold information, the CPU 21 evaluates that the quality of connection with the currently-connected conference server 50 is low when the communication speed in the connection quality information is lower than the value communication speed regarding the threshold information. Further, in a case where the predetermined packet loss ratio is used as the threshold information, the CPU 21 evaluates that the quality of connection with the currently-connected conference server 51 is low when the packet loss ratio in the connection quality information is higher than the predetermined packet loss ratio regarding the threshold information.

The connection quality information shown in FIG. 6 is illustrated as an example. As described above, the conference terminal 10A is connected to the conference server 50A. The average response time between the conference terminal 10A and the conference server 50A is 613 ms and larger than the response time “500 ms′” indicated by the threshold information. That is, in a case of a specific example shown in FIG. 6, the connection quality between the conference terminal 10A and the conference server 50A is evaluated to be “a low quality”.

After the connection quality evaluation process (9), the CPU 21 of the conference terminal 10A determines whether the quality of connection with the connecting conference server 50 is low or not, based on the evaluation results of the connection quality evaluation process (10). When it is determined that the connection quality is low, the CPU 21 causes the processing to proceed to a conference state maintaining process (11). When it is determined that the connection quality is maintained in a quality above a certain level, the CPU 21 returns the processing to the response time measuring process and continues to monitor the degradation of the quality of connection with the conference server 50.

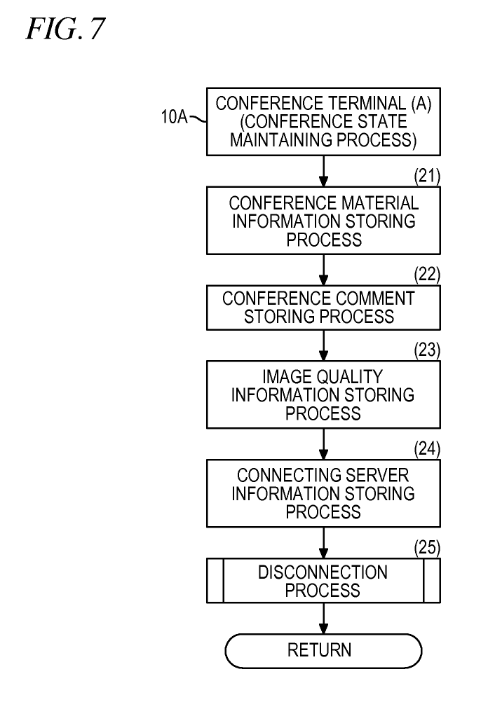

Next, processing contents of a conference state maintaining process to be executed when the quality of connection with the connecting conference server 50 is lowered will be described in detail with reference to FIG. 7.

When the quality of connection with the connecting conference server 50 is low, the CPU 21 of the conference terminal 10A causes the processing to the conference state maintaining process (11). Here, the CPU 21 first executes a conference material information storing process (21). In the conference material information storing process, the CPU 21 stores, in the HDD 30, conference material information indicating the state (for example, data indicating the currently-displayed shared material and data indicating a display position of the shared material (page number, playing time or the like)) of shared data regarding the shared material which is shared in the remote conference and displayed on the display 32 in the ongoing remote conference. Incidentally, the shared material may include document data, media data of moving images, capture images for sharing display screens of applications, chatting image, and the like.

When the conference material information storing process (21) ends, the CPU 21 executes a conference comment storing process (22). In the conference comment storing process (22), the CPU 21 stores, in the HDD 31, conference comment information indicating comments which are drawn in association with the conference material. Meanwhile, the conference comment information is configured by information indicating the coordinate positions and display colors of dots to configure comments drawn on the contents in which the conference material or the like is shared in a certain remote conference. The CPU 21 can reproduce the comments drawn on the conference material by specifying the coordinate position and display color of each dot based on the conference comment information. Incidentally, the conference comment information may include comments input in the conference terminals 10B, 10C and received by the conference terminal 10A via the conference server 50, in addition to comments input in the conference terminal 10

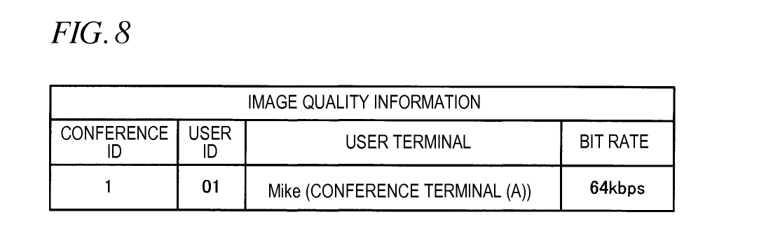

After the conference comment storing process (22), the CPU 21 executes an image quality information storing process (23). Specifically, the CPU 21 stores image quality information of the currently-participating remote conference in the HDD 30. Here, the image quality information is information indicating the quality of the image data transmitted from the conference terminal 10 in the currently-participating remote conference and includes a conference ID, a user ID and a bit rate, as shown in FIG. 8. The conference ID is identification information for identifying the currently-participating remote conference. The user ID is identification information for specifying the conference terminal 10. The bit rate is information indicating the quality of the image transmitted from the conference terminal 10. Here, the image quality information may include, for example, resolution or frame rate in addition to or instead of the bit rate.

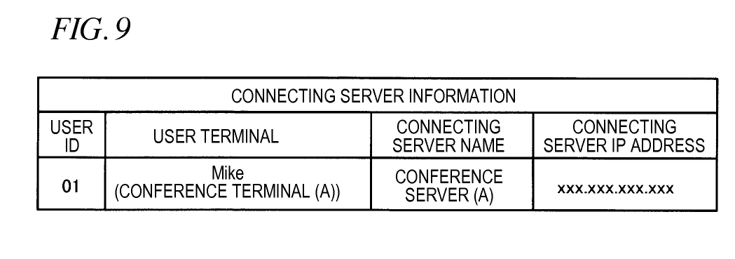

When the image quality information storing process (23) ends, the CPU 21 executes a connecting server information storing process (24). Specifically, the CPU 21 stores, in the HDD 30, connecting server information indicating the conference server 50 to which the conference terminal 10 is currently connected. As shown in FIG. 9, the connecting server information includes a user ID for specifying the conference terminal 10 and a server IP address for specifying the conference server 50 to which the conference terminal 10 is connected. Accordingly, the CPU 21 can specify the currently connected conference server 50 with reference to the connecting server information.

When the connecting server information storing process (24) ends, a variety of information (i.e., conference material information, conference comment information, image quality information and connecting server information) indicating the current state of the remote conference is stored in the HDD 30. Then, the CPU 21 causes the processing to proceed to a disconnection process (25).

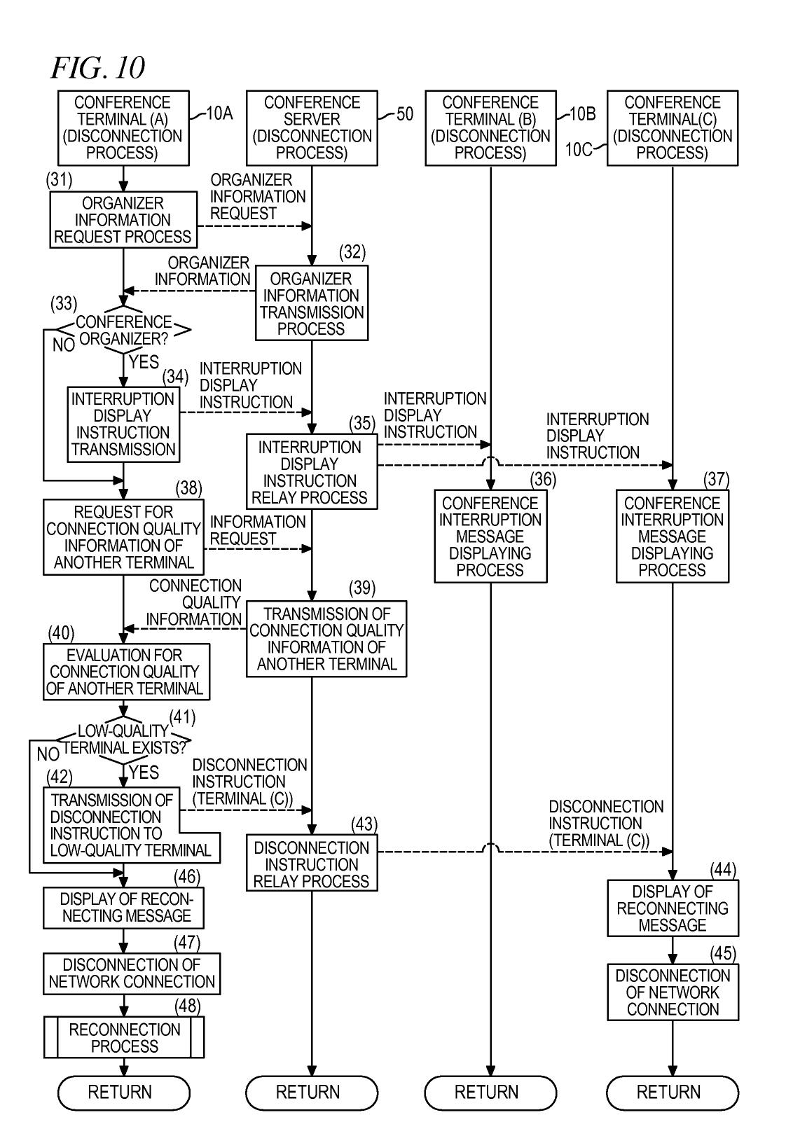

Next, a disconnection process (25) will be described in detail with reference to FIG. 10. Here, the disconnection process is executed when the quality of connection with the connecting conference server 50 is lowered and thus the storing of the conference state in the current remote conference is completed.

When the processing proceeds to the disconnection process (25), the CPU 21 of the conference terminal 10A executes an organizer information request process (31). In the organizer information request process, the CPU 21 requests organizer information indicating an organizer of the current remote conference, to the conference server 50. The organizer information request includes a conference ID regarding the current remote conference.

When the organizer information is requested, the CPU 61 of the conference server 50 reads out the conference information regarding the current remote conference from HDD 71 and transmits the read-out conference information to the conference terminal 10A which has requested the organizer information (32). As shown in FIG. 4, since the organizer ID is included in the conference information, the CPU 61 can transmit the conference information regarding the remote conference, thereby proving the organizer information.

Upon acquiring the organizer information in accordance with the reception of the conference information regarding the current remote conference, the CPU 21 of the conference terminal 10 determines whether or not the conference terminal 10 has an organizer authority in the current remote conference, based on the conference ID included in the organizer information request (33). Specifically, the CPU 21 determines whether or not the organizer ID included in the received conference information matches the user ID regarding the conference terminal 10. When it is determined that the acquired organizer ID matches the user ID regarding the conference terminal 10, the CPU 21 determines that the conference terminal 10 has an organizer authority and transmits an interruption display instruction to each conference terminal 10 participating in the remote conference via the conference server 50 (34). Upon transmitting the interruption display instruction to the conference server 50 (34), the CPU 21 of the conference terminal 10 having the organizer authority requests the connection quality information of the other conference terminals 10 participating in the remote conference, to the conference server 50 (38).

Here, the interruption display instruction is an instruction for instructing the message indicating “the remote conference is interrupted” to be displayed on the display 32 in each conference terminal 10 participating in the remote conference and an example of a second displaying instruction.

Meanwhile, in a case where the acquired organizer ID does not match the user ID of the conference terminal 10, the CPU 21 determines that the conference terminal 10 has no organizer authority and requests the connection quality information of the other conference terminal 10 participating in the remote conference to the conference server 50 (38).

Upon receiving the interruption display instruction transmitted from the conference terminal 10 having the organizer authority, the CPU 61 of the conference server 50 executes an interruption display instruction relaying process (35). In the interruption display instruction relaying process, the CPU 61 transmits the interruption display instruction received from the conference terminal 10 (in this example, the conference terminal 10A) having the organizer authority to the other conference terminals 10 (the conference terminal 10B and the conference terminal 10C) participating in the remote conference.

Upon receiving the interruption displaying instruction relayed via the conference server 50 by the interruption display instruction relaying process (35), the CPU 21 of the conference terminal 10 participating in the remote conference executes a conference interruption message displaying process (36, 37). In the conference interruption message displaying process, the CPU 21 displays message indicating “the remote conference is interrupted” on the display 32 of the conference terminal 10, based on the interruption display instruction relayed from the conference server 50. In a case of this specific example, the message indicating “the remote conference is interrupted” is respectively displayed on the display 32 in the conference terminal 10B and conference terminal 10C, based on the reception of the interruption display instruction.

As described above, the CPU 21 of the conference terminal 10 executes determination (33) regarding the present/absent of the organizer authority and then requests the connection quality information of the other conference terminals 10 participating in the remote conference (38).

When the connection quality information of the other conference terminals 10 participating in the remote conference is requested, the CPU 61 of the conference server 50 transmits the connection quality information regarding the other conference terminals 10 to the conference terminal 10 that is a request source (39).

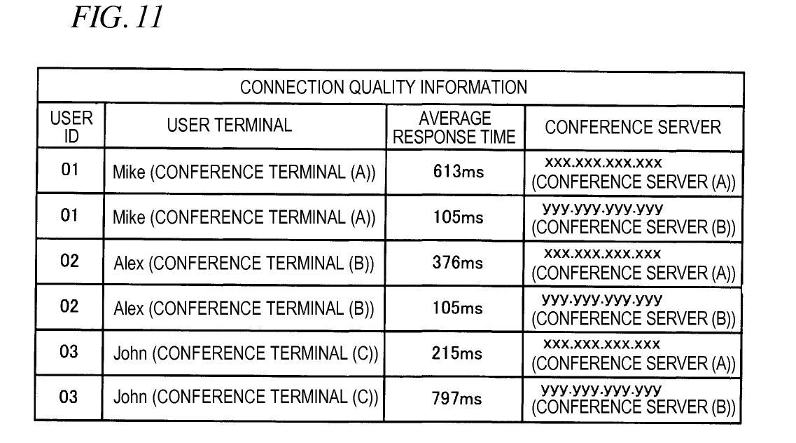

Here, in the illustrative embodiment, the CPU 21 of each conference terminal 10 participating in the remote conference repeatedly executes a connection quality monitoring process shown in FIG. 5 while the remote conference is executed. Accordingly, the connection quality information is frequently transmitted to the conference server 50 from all conference servers 10 participating in the remote conference (4). Upon receiving the connection quality information from the conference terminal 10 participating in the remote conference, the conference server 50 frequently registers the received connection quality information in the HDD 71 (5). Accordingly, as shown in FIG. 11, the connection quality information of all conference terminals 10 participating in the remote conference is stored in the HDD 71 of the conference server 50. Accordingly, the CPU 61 of the conference server 50 can transmit the connection quality information of the other conference terminals 10 participating in the remote conference to the requested conference terminal 10, by referring to the storage content of the HDD 71.

When the CPU 21 of the conference terminal 10 receives the connection quality information of the other conference terminals 10 participating in the remote conference from the conference server 50, the CPU 21 of the conference terminal 10 evaluates the connection quality between the other conference terminal 10 and the conference server 50 connected to the other conference terminal 10 (40). Specifically, the CPU 21 of the conference terminal 10 compares an average response time included in the connection quality information regarding the other conference terminal 10 with the value (for example, 500 ms) of response time included in the threshold information and evaluates the connection quality between the other conference terminal 10 and the conference server 50 to which the other conference terminal 10 is connected.

In this regard, the connection quality information shown in FIG. 11 is illustratively described. As described above, the conference terminal 10B is connected to the conference server 50A. As shown in FIG. 11, an average response time between the conference terminal 10B and the conference server 50A is 376 ms and the response time indicated by the threshold information is “500 ms” or less. That is, in a case of a specific example shown in FIG. 11, the connection quality between the conference terminal 10B and the conference server 50A is evaluated to be “maintained at a predetermined quality or more”. Further, the conference terminal 10C is connected to the conference server 50B and an average response time between the conference terminal 10C and the conference server 50B is 797 ms. Accordingly, in a case of a specific example shown in FIG. 11, since the average response time between the conference terminal 10C and the conference server 50B is larger than the response time, “500 ms” in the threshold information, the connection quality between the conference terminal 10C and the conference server 50B is evaluated to be “a low quality”.

Referring to FIG. 10 again, a processing after evaluating the connection quality between the other conference terminal 10 participating in a remote conference and the conference server 50 connected to the other conference terminal 10 will be described. First, the CPU 21 of the conference terminal 10 determines whether or not the conference terminal 10 (hereinafter, referred to as a low-quality terminal) evaluated as a low connection quality is present among the other conference terminals 10 participating the remote conference, based on the evaluation results of the connection quality in the other conference terminal 10 (41). When it is determined that a low-quality terminal is present among the other conference terminals 10, the CPU 21 transmits the disconnection instruction to the conference terminal 10 corresponding a low-quality terminal via the conference server 50 (42). Here, the disconnection instruction includes identification information for identifying the other conference terminal 10 evaluated as a low-quality terminal that is a destination, an instruction for instructing the disconnection of the network connection with the currently-connected conference server 50 and an instruction for instructing “the conference terminal is reconnected to the conference server 50” to be displayed on the display 32. That is, the disconnection instruction serves as an example of a disconnection instruction and a first displaying instruction.

Upon receiving the disconnection instruction from the conference terminal 10, the CPU 61 of the conference server 50 executes a disconnection instruction relaying processing (43). As described above, since the disconnection instruction is transmitted to the other conference terminal 10 evaluated as a low-quality terminal that is a destination, the CPU 61 relays the received disconnection instruction to the other conference terminal 10 evaluated as a low-quality terminal, based on the identification information for identifying the conference terminal, which is included in the disconnection instruction. In a case of a specific example shown in FIG. 11, the disconnection instruction is relayed to the conference server 10C by the conference server 50.

Upon receiving the disconnection instruction relayed by the conference server 50, the CPU 21 of the conference terminal 10 corresponding to a low-quality terminal displays, on the display 32, a reconnecting message indicating “the conference terminal is reconnected to the conference server 50” (44). Accordingly, in a case of a specific example shown in FIG. 11, the reconnecting message is displayed on the display 32 of the conference terminal 10C.

After displaying the reconnecting message on the display 32, the CPU 21 associated with a low-quality terminal disconnects the network connection with the conference server 50 that is currently connected to the conference terminal 10 (45). Accordingly, in a case of a specific example shown in FIG. 11, the network connection between the conference terminal 10C and the conference server 50B is disconnected.

Further, when the network connection is disconnected in accordance with the reception of a disconnection instruction, the CPU 21 associated with a low-quality terminal executes a line speed comparison process (51) to a conference information displaying process (63), which will be described later. That is, the reconnection of the network is executed for the conference server 50 having a higher communication quality.

After transmitting a disconnection instruction to the conference terminal 10 corresponding to a low-quality terminal or when it is determined that a low-quality terminal is not present among the other conference terminals 10 participating in the remote conference (41: NO), the CPU 21 of the conference terminal 10 displays the reconnecting message on the display 32 (46).

After displaying the reconnecting message on the display 32, the CPU 21 of the conference terminal 10 disconnects the network connection with the currently-connected conference server 50 because the connection quality between the conference terminal 10 and the conference server 50 is a low quality (47). After disconnecting the network connection, the CPU 21 causes the processing to a reconnection process (48).

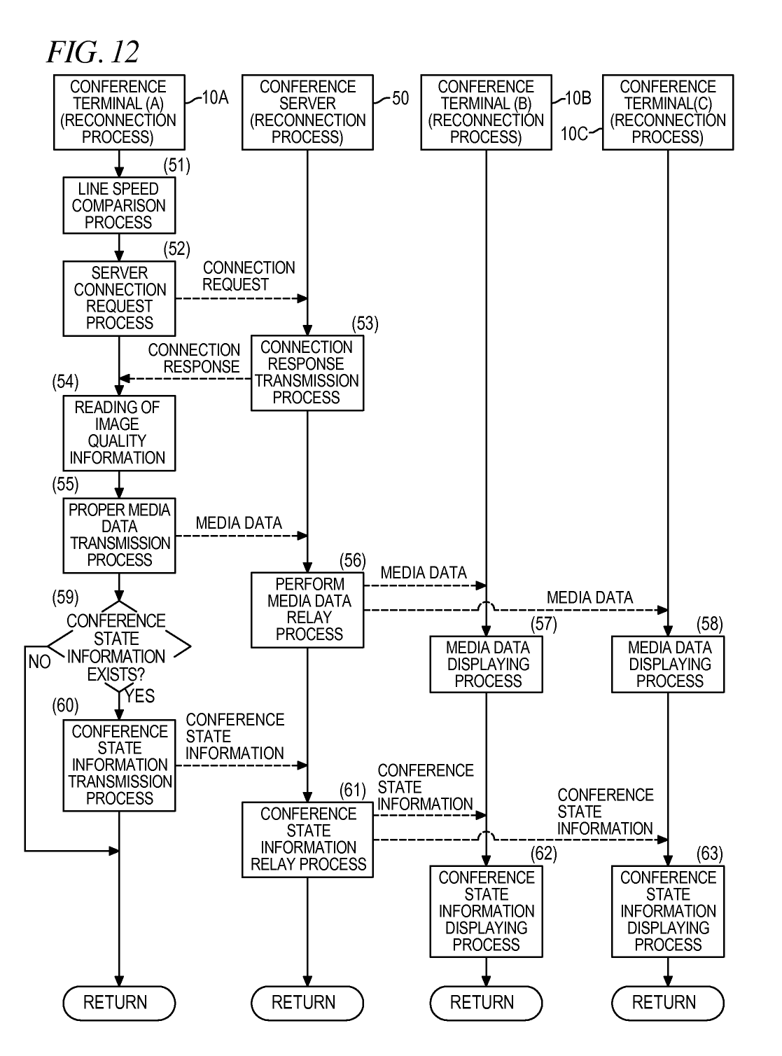

A reconnection process to be executed after disconnecting the network connection evaluated as a low quality by the disconnection process will be described in detail with reference to FIG. 12. First, the CPU 21 of the conference terminal 10 executes a line speed comparison process, based on the connection quality information between the conference terminal 10 (i.e., the conference terminal 10A) and each conference server 50 to configure the remote conference system 1. Specifically, the CPU 21 compares the average response time included in the connection quality information between the conference terminal 10 and each conference server 50 and specifies the conference server 50 having the fastest line speed (i.e., the shortest average response time).

After the line speed comparison process (51) ends, the CPU 21 of the conference terminal 10 transmits connection request to the conference server 50 having the fastest line speed specified in the line speed comparison process (52). In a case of a specific example shown in FIG. 11, since the average response time to the conference server 50A is “613 ms” whereas the average response time to the conference server 50B is “105 ms”, the connection request is transmitted to the conference server 50B.

Upon receiving the connection request, the CPU 61 of the conference server 50 establishes the network connection between the conference terminal 10 that transmits the connection request and the conference server 50 and sends the connection response indicating the completion of the network connection to the conference terminal 10 that transmits the connection request (53).

Upon receiving the connection response from the conference server 50 having a higher connection quality than before, the CPU 21 of the conference terminal 10 reads out the image quality information stored by the above-described image quality information storing process (23) from the HDD 30 (54).

After reading out the image quality information from the HDD 30, the CPU 21 of the conference terminal 10 executes an appropriate media data transmitting process (55). Specifically, the CPU 21, first, sets the image quality of the image data used in the remote conference resumed after reconnecting to the image quality (for example, resolution, frame rate, or bit rate) lower than the image quality before disconnecting the network connection, based on the image quality information read-out from the HDD 30. That is, the appropriate media data refers to the media data including image data which is created in the image quality lower than the image quality before disconnecting the network connection. Then, upon creating the appropriate media data, the CPU 21 transmits the appropriate media data to the other conference terminal 10 participating in the remote conference via the reconnected conference server 50.

Upon receiving appropriate media data, the CPU 61 of the conference server 50 executes an appropriate media data relaying process and transmits the received appropriate media data to each conference terminal 10 participating in the remote conference.

Upon receiving the appropriate media data relayed by the conference server 50, the CPU 21 of each conference terminal 10 participating in the remote conference executes a media data displaying process (57, 58). Specifically, the CPU 21 of each conference terminal 10 displays, on the display 32, the image data included in the received appropriate media data and outputs, from the speaker 35, the sound data included in the appropriate media data.

As described above, since the image data regarding appropriate media data is created in image quality (i.e., having lower resolution, frame rate, bit rate) lower than the image quality before the disconnection of the network connection, it is possible to suppress occurrence of the communication delay when transmitting the image data to each conference terminal 10 participating in the remote conference. That is, upon resuming the remote conference, the image data can be reproduced without being delayed and therefore it is possible to smoothly continue the remote conference.

Also, upon being reconnected to the conference server 50 having connection quality higher than before disconnecting, the CPU 21 of the conference terminal 10 determines whether or not the conference state information indicating the state of the remote conference interrupted due to the disconnection of the network connection is stored in the HDD 30 by the conference state maintaining process (11) (59). Here, the conference state information at least includes the conference material information stored in the conference material information storing process (21) and the conference comment information stored in the conference comment storing process (22). In a case where the conference state information is stored in the HDD 30, the CPU 21 transmits the conference state information to each conference terminal 10 participating in the conference terminal via the reconnected conference server 50 (60). On the contrary, in a case where the conference state information is not stored in the HDD 30, the CPU 21 executes transmission/reception of the media data associated with the progress of ordinary remote conference.

Upon receiving the conference state information, the CPU 61 of the conference server 50 executes a conference state information relaying process and transmits the received conference state information to each conference terminal 10 participating in the remote conference (61).

Upon receiving the conference state information relayed by the conference server 50, the CPU 21 of each conference terminal 10 participating in the remote conference executes a conference state information displaying process (62, 63). Specifically, the CPU 21 of each conference terminal 10 displays, on the display 32, the conference material that was displayed on the display 32 in the remote conference before the disconnection of the network connection based on the conference material information included in the received conference state information, thereby reproducing the state of the remote conference before the disconnection of the network connection. Further, the CPU 21 of each conference terminal 10 displays the comments or the like drawn to the conference material on the display 32, based on the conference comment information included in the received conference state information, thereby reproducing the comments or the like before the disconnection of the network connection.

As described above, the conference material information and the conference comment information included in the conference state information indicates the state of the remote conference before being interrupted by the disconnection of the network connection. Accordingly, according to the remote conference system 1, since the state of the remote conference immediately before interruption can be reproduced when resuming the remote conference at the reconnection of the network, it is possible to smoothly continue the remote conference after resumption.

As described above, the remote conference system 1 according to the illustrative embodiment includes a plurality of conference servers 50 for relaying the media data including the image data or the sound data and a plurality of conference terminals 10 communicatively connected to the conference servers 50 via the network N. A remote conference can be executed by transmitting and receiving the media data between the plurality of conference terminals 10 connected to the conference servers 50 via the network N.

Further, the conference terminal 10 according to the illustrative embodiment monitors the connection quality of the network connection with the conference server 50 by the connection quality monitoring process. The conference terminal 10 disconnects the network connection with the connecting conference server 50 (47) and then executes the reconnection to the conference server 50 (52, 53) when it is determined that the quality of connection with the connecting conference server 50 is lower than a predetermined quality. Therefore, in the conference terminal 10, it is possible to improve the connection quality between the conference terminal 10 and the conference server 50 without requiring a complicated operation to a user.

In addition, the conference terminal 10 executes the conference state storing process (11) to store the conference state information in the HDD 30 before disconnecting the network connection with the conference server 50 when it is determined that the quality of connection with the connecting conference server 50 is lower than a predetermined quality. Further, upon executing the reconnection to the conference server 50, the conference terminal 10 can reproduce the state (the state of the conference comment or the conference material) of the remote conference before disconnecting the network, based on the conference state information stored in the HDD 30, and therefore, it is possible to smoothly resume the interrupted remote conference by the disconnection and reconnection of the network connection.

According to the conference terminal 10 of the illustrative embodiment, after the network connection with the conference server 50 connected thereto during the remote conference is disconnected, the conference terminal 10 acquires the connection quality information indicating the quality of connection with the connecting conference server 50 and the other conference server 50 configuring the remote conference system 1 (51) and executes the reconnection of the network to the conference server 50 having higher connection quality (52, 53). That is, according to the conference terminal 10, since the conference terminal 10 can transmit and receive the media data to and from the other conference terminal 10 via the conference server 50 in a situation of higher connection quality, it is possible to smoothly continue the remote conference after the reconnection.

Further, in the conference terminal 10 according to the illustrative embodiment, the conference state information stored in HDD 30 is transmitted to the reconnected conference server 50 after the network between the conference terminal and the conference server 50 having a higher connection quality is reconnected (60). Thereby, since the other conference terminal 10 participating in the remote conference can acquire the conference state information transmitted to the reconnected conference server 50, it is possible to reproduce the state (the state of the conference comment or the conference material) of the remote conference before disconnecting the network, based on the conference state information (61, 62, 63). As a result, according to the conference terminal 10, the remote conference interrupted due to the disconnection and reconnection of the network connection can be resumed more smoothly.

Further, in the conference terminal 10 according to the illustrative embodiment, the image quality information regarding the media data used in the ongoing remote conference is stored in the HDD 30 before disconnecting the network connection (23) and the remote conference is resumed using the media data including the image data having the quality lower than the quality of the image data included in the stored conference state information when the remote conference is resumed in accordance with the reconnection of the network (54 to 58). Accordingly, in the conference terminal 10, the remote conference interrupted due to the network disconnection can be resumed while reducing the possibility of the missing or delay of image, thereby advancing the remote conference smoothly after interruption.

Further, in the remote conference system 1 according to the illustrative embodiment, all conference terminals 10 configuring the remote conference system 1 repeatedly execute the connection quality monitoring process, measure the quality of connection with each conference server 50 configuring the remote conference system 1 (14) and frequently register the measurements on the HDD 71 of the conference server 50 (5). Further, the conference terminal 10 acquires the connection quality information of the other conference terminals 10 configuring the remote conference system 1 when disconnecting the connecting network (38, 39) and executes the disconnection process for the other conference terminal in which the quality of connection with the connecting conference server 50 is lower than a predetermined quality (42). Thereby, since the network connection having a low connection quality is disconnected, and the reconnection is executed in the other conference terminal 10 having a low connection quality (45), it is possible to improve the connection quality of the network connection even for the other conference terminal 10. Further, since the disconnection/reconnection of the network to the conference terminal 10 having a low connection quality can be executed at the same time between respective conference terminals 10 participating in the remote conference, it is possible to reduce the interruption frequency of the remote conference, thereby contributing to the smooth progress of the remote conference.

Further, the conference terminal 10 displays the reconnecting message on the display 32 of the conference terminal 10 whose network connection is disconnected before disconnecting the network connection to the connecting conference server 50 (42 to 46). Accordingly, in the conference terminal 10, a user can understand by the reconnecting message on the display 32 that the remote conference is interrupted and the network is reconnected.

Further, the conference terminal 10 determines whether or not the conference terminal 10 has an organizer authority when disconnecting the network connection with the connecting conference server 50 (31 to 33) and executes the interruption display instruction for the other conference terminals 10 participating in a remote conference when it is determined that the conference terminal 10 has the organizer authority (34, 35). Upon receipt of the interruption display instruction, the other conference terminals 10 display the conference interruption message on the display 32 (36, 37). Here, since an organizer of the remote conference often plays an important role in the progress of the remote conference, the progress of the remote conference is delayed in a state where the conference terminal 10 having the organizer authority cannot participate in the remote conference due to the disconnection of the network connection. In this case, according to the conference terminal 10, since the conference interruption message is displayed on the display 32 of the other conference terminals 10 participating in the remote conference, a user of the other terminal participating in the remote conference can understand that the remote conference is interrupted and thus the progress of the conference is delayed.

While the present invention has been shown and described with reference to certain illustrative embodiments thereof, it will be understood by those skilled in the art that various changes in form and details may be made therein without departing from the spirit and scope of the invention as defined by the appended claims.

For example, although the above illustrative embodiment has a configuration that the conference terminal 10 stores the conference state information in the HDD 30 before disconnecting the network connection when the quality of the network connection with the connecting conference server 50 is lower than a predetermined connection quality, the conference state information may be stored in the HDD 71 of the conference server 50.

Specifically, when the quality of the network connection between the conference terminal 10 and the connecting conference server 50 is lower than a predetermined connection quality (10), the conference state information storing instruction is transmitted from the conference terminal 10 to the conference server 50 before disconnecting the network connection.

Upon receiving the conference state information storing instruction, the conference server 50 executes the processing similar to the conference material information storing process (21), the conference comment storing process (22), the image quality information storing process (23) and the connecting server information storing process (24), thereby storing the conference material information, the conference comment information, the image quality information and the connecting server information in the HDD 71 of the conference server 50.

Meanwhile, the conference material information, the conference comment information, image quality information and the connecting server information may be transmitted from the conference terminal 10, along with the above-described conference state information storing instruction. Further, these types of information may be acquired by any method, as long as the information can be stored in the HDD 71 of the conference server 50.

Further, although the above-described embodiment has a configuration that a variety of information such as the conference information (FIG. 4), the connection quality information (FIG. 6 and FIG. 11), the image quality information (FIG. 8) and the connecting server information (FIG. 9) is stored in the HDD 71 of the conference server 50, the present invention is not limited thereto. For example, a database (DB) server for centrally managing these various types of information may be further provided in the remote conference system 1. In this case, the conference terminal 10 transmits a variety of information to the conference server 50 which, in turn, sends a variety of information to the DB server.

What is claimed is:

1. A non-transitory computer-readable medium storing computer-readable instructions that, when executed by a processor of a communication terminal, instruct the processor to perform processes comprising:
detecting a first quality value indicating a quality of connection with a first conference server based on a packet transmitted to the first conference server and a packet received from the first conference server, wherein the first conference server is configured to communicate media data relating to a remote conference with the communication terminal;
determining whether the quality of connection with the first conference server is lower than a predetermined quality based on the first quality value;
when it is determined that the quality of connection with the first conference server is lower than the predetermined quality, outputting a conference state storing instruction to store a state of an ongoing remote conference;
disconnecting a network connection with the first conference server after conference state information indicating the state of the ongoing remote conference is stored in response to the conference state storing instruction;
reconnecting the network connection with the first conference server after the network connection is disconnected; and
when the network connection is reconnected with the first conference server, resuming the ongoing remote conference based on the stored conference state information.

2. The non-transitory computer-readable medium according to claim 1,
wherein the conference state storing instruction instructs to store the conference state information in the communication terminal,
wherein the processes further comprise:
detecting a second quality value indicating a quality of connection with a second conference server connected to the first conference server via a network, based on a packet transmitted to the second conference server and a packet received from the second conference server; and
after the network connection with the first conference server is disconnected, specifying the second conference server having a higher quality of connection with the communication terminal than the first conference server based on the first quality value and the second quality value, and reconnecting a network connection with the specified second conference server.

3. The non-transitory computer-readable medium according to claim 2,
wherein the processes further comprise:
when the network connection is reconnected with the second conference server, transmitting the conference state information stored in a storage device of the communication terminal to the second conference server.

4. The non-transitory computer-readable medium according to claim 1,
wherein the conference state storing instruction instructs to store the conference state information including a quality of image data in the media data which is communicated in the ongoing remote conference, and
wherein the resuming process resumes the ongoing remote conference using media data which includes image data having a quality lower than the quality of image data included in the stored conference state information.

5. The non-transitory computer-readable medium according to claim 1,
wherein the processes further comprise:
uploading the first quality value to the first conference server; and
acquiring, from the first conference server, a third quality value which is uploaded from another communication terminal participating in the remote conference and indicates a quality of connection between the other communication terminal and a specific conference server connecting with the other communication terminal,
wherein the disconnecting process includes instructing the other communication terminal determined to have a quality of connection with the specific conference server lower than a predetermined quality based on the third quality value, to disconnect a network connection with the specific conference server.

6. The non-transitory computer-readable medium according to claim 1,
wherein the disconnecting process includes, before disconnecting with the first conference server, transmitting a first display instruction to instruct another communication terminal which is to be disconnected with a specific conference server connecting with the other terminal to display that a network connection with the specific conference server is being reconnected.

7. The non-transitory computer-readable medium according to claim 6,
wherein the processes further comprise:
determining whether the communication terminal has authority information indicating that the communication terminal is an organizer of the remote conference,
wherein the disconnecting process includes transmitting a second display instruction to instruct another communication terminal participating in the remote conference to display that the remote conference is interrupted when it is determined that the communication terminal has the authority information.

8. A communication terminal comprising:
a processor; and
memory storing computer-readable instructions that, when executed by the processor, instruct the processor to perform processes comprising:
detecting a first quality value indicating a quality of connection with a first conference server based on a packet transmitted to the first conference server and a packet received from the first conference server, wherein the first conference server is configured to communicate media data relating to a remote conference with the communication terminal;
determining whether the quality of connection with the first conference server is lower than a predetermined quality based on the first quality value;
when it is determined that the quality of connection with the first conference server is lower than the predetermined quality, outputting a conference state storing instruction to store a state of an ongoing remote conference;
disconnecting a network connection with the first conference server after conference state information indicating the state of the ongoing remote conference is stored in response to the conference sate storing instruction;
reconnecting the network connection with the first conference server after the network connection is disconnected; and
when the network connection is reconnected with the first conference server, resuming the ongoing remote conference based on the stored conference state information.
